(19) United States
(12) Patent Application Publication
(10) Pub. No.: US 2025/0165512 A1
(43) Pub. Date: May 22, 2025

(54) COMPUTER-IMPLEMENTED METHODS FOR PROVIDING ARTIFICIAL-INTELLIGENCE SYSTEM RESPONSES TO CLIENT REQUESTS

(71) Applicant: Supertab AG, Steinhausen (CH)

(72) Inventor: Cosmin-Gabriel Ene, Zollikon (CH)

(21) Appl. No.: 18/952,383

(22) Filed: Nov. 19, 2024

(30) Foreign Application Priority Data
Nov. 20, 2023 (IE) S2023/0489
Aug. 12, 2024 (GB) 2411876.2

(51) Int. Cl. G06F 16/3329; G06Q 20/12; G06Q 20/40; H04L 51/02

(52) U.S. Cl. CPC G06F 16/33295; G06Q 20/123; G06Q 20/401; H04L 51/02

(57) ABSTRACT

A method for providing an artificial-intelligence system response to a client request including the steps of:
a) receiving a client request from a client component;
b) determining a client identity (ID) of a user issuing the request;
c) processing the client request to identify at least one content source providing paywalled content for responding to the client request;
d) determining a cost and deferred payment terms t for obtaining the paywalled content;
e) confirming a selection of the paywalled content based on a characteristic of the client and the payment terms of the at least one content source;
f) Issuing a secondary request to the content source to provide the paywalled content;
g) receiving the selected content;
h) inputting parts of the received content and the client request into at least one trained model; and
i) transmitting the output of the trained model to the client component.

### CROSS-REFERENCE TO RELATED APPLICATIONS

This application claims priority under 35 U.S.C. § 119 from Irish Patent Application No. S2023/0489, filed on Nov. 20, 2023, and UK Patent Application No. 2411876.2, filed on Aug. 12, 2024, each of which is hereby incorporated by reference in its entirety herein.

### FIELD OF THE INVENTION

The invention relates to a method for providing a response to a client request and a system for providing a chat conversation.

### BACKGROUND

Systems for providing online chat conversations are known. In the past, it has been becoming increasingly popular to have chatbots or chatter bots, which participate in chats conducted with human beings. In the recent years, there has been a development in the service sector to use chatbots for responding to customer requests, e.g. to answer simple questions about pricing, service conditions and so forth. The respective chatbots serve to reduce the workload on human service persons and filter out the most basic questions so that the human beings can respond to more complicated and sophisticated questions.

With the increasing progress that has been made with trained models like neural networks and others, the capability of so-called chatbots to respond to more complex questions increased. In November 2022, OpenAI launched Chat Generative Pre-Trained Transformer, also known as ChatGPT. ChatGPT provides a chatbot that uses an autoregressive language model generated by deep learning to produce human-like text. Using Large Language Models (LLMs), the technology has shifted from the field of responding to predefined questions into an area where longer texts can be generated.

For providing sophisticated answers and generating text, applications like ChatGPT require massive calculation power and therefore consume an excessive amount of energy. Therefore, there is an increasing need to provide economically sensible approaches to coordinate the use of such systems.

Further, there is the increasing problem of how to handle copyright-protected content which in some scenarios can be hidden behind a paywall. Some LLMs are trained on copyright-protected data and it is virtually impossible to trace a particular response given by a chatbot using an LLM back to one or several sources which to a certain degree form the basis of said particular answer. This makes a fair compensation of the authors of the paid content impossible, owing to the unsolved technical problem of mapping responses to sources.

Further, there is the problem of accessing paywalled content due to complicated case-by-case access solutions. This makes it difficult for users but also for machines to access certain paywalled content. For a machine, each integration of a new content provider typically requires special publishing software installation. There is also a risk for consumers of paywalled content in that the consumer is tracked and/or exposed to malicious software. A further issue with available content sharing is the risk of the shared content interfering with originators' search engines optimization.

Another technical problem lies in that the LLMs have been trained with data, which has been available up to a certain point in time. In other words, the most recent data is not available to the LLMs. Further, the training requires large amounts of training data and, for conducting the training, large amounts of energy. For example, training a new LLM just for implementing the most recent data of the last year would be inefficient regarding energy consumption.

In the end, the above problems lead to a situation in which certain content, in particular paywalled content, cannot be processed by LLMs which might have a significant impact on the quality of the response generated or more abstractly speaking of the service provided using the LLMs.

Given this prior art, it is an objective of the present application to provide an improved method for providing the responses to client requests. It is also an objective to provide the responses to client requests in an energy-efficient manner.

### SUMMARY

The present invention solves the respective problem by a method in accordance with claim 1, a computer-readable medium in accordance with claim 9 and a system in accordance with claim 1.

In particular, the problem is solved by a for providing an artificial-intelligence system responsive to a client request, including the steps of
a) receiving a client request over an interface from a client device;
b) determining a client identity of a user issuing the request;
c) processing the client request to identify at least one content source which provides content, in particular paywalled content (relevant) for responding to the client request;
d) obtaining an index of content based on the user request, wherein the index identifies paywalled content of the at least one content source;
e) determining a cost and payment terms of the at least one content source for a deferred payment arrangement for obtaining the paywalled content;
f) confirming a selection of the paywalled content of the at least one content source based on a characteristic of the client and the associated payment terms of the at least one content source;
g) issuing at least one secondary request to the identified/selected content source to provide content;
h) receiving content from the identified/selected content source in response to the secondary request;
i) inputting at least parts of the received content and at least parts of the client request into at least one trained model, in particular an autoregressive language model, preferably a deep learning model; and
j) transmitting at least partially the output of the trained model to the client device to provide the response to the client request.

Optionally, the method can also comprise the following step:
k) allocating an amount to be paid for the transmission of the response, preferably without concurrently requiring payment of the amount, using the client identity.

The request from the client can comprise an image, a text and/or audio/video data. Correspondingly, the response can be a text, an image or an audio/video data. The received client request can be a client request that is generated e.g. via a web interface as it is common in chat programs, and an AI-prompt keyboard key, e.g., the Copilot key to be implemented by Microsoft Corp. via windows-based computer keyboards. Alternatively, the respective request can be generated by any other means, e.g. by a word processing software like Microsoft Word, a drawing program, a software running in a car or any other type of device.

In accordance with the invention, the client request can stem from any type of client component (executed software or hardware). The client device is just one example and used as such in the following text.

Step c) can be a processing step, e.g., a step of data extraction and/or pattern matching. In one embodiment, the client request could for example already contain a descriptive name of a particular data source: “Please summarize the title page of the New York Times”. Alternatively, certain keywords can be extracted and e.g. used in a search request, e.g. a Google search, to determine an adequate data source. The client request might for example relate to statistics, e.g. the birth rate in Germany. In accordance with the inventive method, “birth rate Germany” can be extracted and a Google search can be issued targeting for data sources providing information about respective birth rates, e.g. a search can be issued for “top data sources Germany birth rate”.

In one embodiment, after step e), the steps of providing pricing from the content source to the client component; and acknowledging pricing by the client component are performed.

In one embodiment, the pricing is zero and the user acknowledges providing a service. Providing a service may be worth a certain amount of money that can be used to compensate or trade for paywalled content.

In one embodiment, bypassing a paywall of the content server is performed at step c). Thereby, access is granted to restricted information, which improves the quality of the response and contributes to an efficient processing.

In one embodiment, step i) can comprise the step of issuing a primary request to the trained model, requesting the model to summarizes the content or parts of the content that was received from the identified/selected content source.

Alternatively, the primary request can instruct the trained model to use the received content to enhance an answer to the client request. E.g. assuming that the client request was “Tell me about cloning.”, the primary request could be “Taking into consideration the following latest article of cloning ([Text of the article]) explain cloning.”

Alternatively, the autoregressive language model can be used to either extract search terms and/or already propose content sources. Staying within the context of the already made example of birth rates in Germany, the autoregressive language model could be requested to “provide a list of top content sources for responding to said client request” and/or to “provide search terms which could be used to search for relevant content sources”. Of course, any of the above described approaches could be limited to so-called paywalled content.

In one embodiment, step i) includes the step of generating an output by the trained model.

Generally, it is one objective of the present invention to receive a client request, use (at least partially) the respective client request to identify/select content sources, select at least one relevant content source and communicate with the respective content source to receive additional data/content. The received content can then be used/digested by a trained model, e.g. an autoregressive language model to generate a response.

By the respective approach, data which has not been part of the training process for the trained model, e.g. because it a) is copyright protected, b) requires payment or c) is more recent than the latest training phase performed for the trained model, can be accessed and used for providing a most accurate response to the issued request

The allocation of an amount to be paid in step k) is optional. In the alternative to such payment, the client component, e.g. client device, the user or any other entity involved can be requested to perform a certain service, e.g. watch a video stream, listen to an audio stream, fill out a form, provide information, e.g. personal information, and/or take any other action that might be suitable to compensate for the received response. In accordance with the invention, the respective compensating action might be performed prior to step d).

In one embodiment, an amount to be paid for the transmission of the response is allocated. The respective amount can be dedicated to the service provided through the trained model and/or for the content received from the content source. In one embodiment, the allocated amount covers both.

In one embodiment, the secondary request is directed to receiving a content, in particular a content related to the client request.

In one embodiment, the method comprises the steps of, preferably after step g):
g1) determining, based at least on part on information from the content source, costs for receiving a response to the secondary request;
g2-1) allocating the amount in step g1) by interacting with a (micro) payment system; or
g2)-2) allocating the amount (270) in step g) to a chat system (20) comprising the at least one trained model (22) by using at least in part a (micro) payment system (30).

According to the invention, the content source can be used to determine the allocated amount, e.g. a request via a (standardised) API can be issued to the content source requesting costs. Coming back to the example of the New York Times, the (computer-implemented) method might request the costs for receiving the most recent title page from a content source/service providing the respective content, e.g. an online issue of the New York Times.

In one embodiment, the method comprises the step of:
g1a) transmitting a cost indication to the client device based on the determined costs, where the allocation to the client identity (ID) in accordance with step g2-1) only takes place if an authorisation signal is received, the authorisation signal indicating that the user of the client device is accepting to allocate an amount that correlates to the cost indication for receiving the response to the client request.

This authorisation signal can also be an authorisation message. In one embodiment, the method includes inquiring with the client device and/or a user thereof whether accessing the paid content is acceptable and whether the client/client device is willing to spend the respective costs.

The determining of a client identity is necessary to link the allocated amounts to a particular user, e.g. a participant in a chat, and/or a client component. For the present invention it is not necessary to identify the person/device as long as there is another mechanism, e.g., via hardware and/or software, that links to the respective client or client identity. Also, it is not necessary to receive much information from the particular user, e.g. via a registration process. To identify the client device and/or the user, any type of hardware identification number can be used such as a MAC address (Media-Access-Control) and/or a processor identification number and/or a hard disk identification number and/or an IP address and/or other unique device numbers, such as the unique device identifier (UDID) of a smartphone. Also modern communication protocols provide access to mechanisms which allow identifying users and/or client devices. Such mechanisms can also be used to arrive at a client identity. The client identity can be any type of number or character and must not necessarily be unique to a single device and/or a single user. Some methods which can be used to establish a client identity in accordance with the inventive concept are discussed in WO 2021/259608 A1, which is incorporated by reference herein.

According to one embodiment, the content received in step h) is received after the user has agreed to the costs for the paywalled content.

As said, in one embodiment of the invention, the generating of the response is linked to the allocation of an amount to be paid. The amount does not need to be paid immediately. The debt is only noted and allows an immediate progressing of the matter, e.g. receiving a response without performing a payment. Thereby, convenient, time-efficient and energy-efficient access becomes possible.

In one embodiment, a payment will only be required if the summed up amount reaches/exceeds a certain/predetermined threshold value/amount and/or has not been paid for a longer time period, e.g. within a month or two weeks.

By combining the concept of micropayments and/or fractional payments with the technology of chatbots, a very efficient approach to generating responses is achieved. While the micropayments or fractional payments do not constitute a significant hurdle to use the provided service, it filters the amount of requests and allows reducing the load on the servers that implement the method. Further, the payment system can be used to settle (immediately or at a later stage) costs for the paywalled content.

In one embodiment, the (predetermined) threshold amount is variable, in particular, increases after a payment has been received from the client ID and/or payment information from the client ID has been acquired and, optionally, verified.

Thereby, usage of the method can be increased and the positive effects of the invention can be put to wider use.

In accordance with the invention, a fractional payment can be defined as a payment wherein the amount to be paid is a fraction of the smallest physical unit available as an official currency, e.g. a quarter of a Eurocent. However, digital currencies like Bitcoin may also be used.

In another embodiment, if step g2-2) is performed, the one or more allocated amounts are allocated from the chat system to the client identity.

Optionally, if a plurality of allocated amounts are allocated to the chat system, those accumulated amounts may be allocated to the client identity. Optionally, the client may settle the amount allocated to the client identity in full or partly.

In another embodiment, before step g), the following steps are performed. In a step g01): Obtaining an index of content based on the client request, wherein the index identifies paywalled content of the at least one content source. In a step g02): Determining a cost and payment terms of the at least one content source for a deferred payment arrangement for obtaining the content. In a step g03): based on the associated payment terms of the at least one content source, confirming a selection of the paywalled content of the at least one content source.

The confirmation of the selection may be performed by the at least one trained model. Optionally, the at least one trained model may select the content based on a likeliness of the information obtained in the index of content to match the client request. Optionally, a plurality or all contents may be selected.

In one embodiment, the method may comprise a forecasting step to determine costs for at least one of the response issued by the trained model. A payment system can be used to compensate the use of the trained model as well as the use of the content as provided by the at least one content server. The forecasting can take one of the following parameters into consideration:
estimated electricity for determining the response;
required electricity for determining the response;
estimated calculation power for at least partially determining the response;
required calculation power for at least partially determining the response;
time to process;
priority of the request;
amount of content sources to be used to generate the answer to the request.

In one embodiment, the forecast (additionally) depends on the load of the server that hosts the trained model. E.g. there can be a weighting factor which leads to an up lift or down lift of the calculated cost. E.g. if the load is higher than average the costs will be increased by 20% (weighting factor=1.20). If it is lower than average costs will be decreased by 10% (weighting factor=0.90). Thereby the inventive method helps to distribute the load on servers evenly over time. Load peaks are avoided which helps to establish a setting which has better average workload.

For estimating electricity and/or calculation power, the method can use adequate models which take into consideration electricity consumption and/or required calculation power for responding to previous requests and/or for generating previous responses. Again, trained models can be used.

In one embodiment, the method may comprise the steps of:
n) issuing at least one invitation message to the client device offering a reward for feedback on the provided response in step g),
o) receiving a feedback message from the client device on the response as transmitted in step a);
p) using the feedback message to train and/or customize and/or otherwise inform the trained model;
q) optionally, reducing the allocated amount to be paid in response to receiving the feedback message.

In one embodiment, the offering of a reward for the feedback is based on a static amount, e.g. 5 Cents, 10 Cents or 1 Euro.

In one embodiment, the offered reward can be linked to a number of questions that the user is willing to answer. In other words, the user may provide a service in exchange for access to the content.

Similarly, the invitation message can describe the algorithm according to which the reward is calculated or provide a tangible value. Alternatively, the invitation message can simply state that there will be a reward and the reward is calculated once the feedback is received. According to this, the allocated amount for the particular user and/or client device is reduced in response to receiving the feedback message. Again, the amount can be calculated at the time of the reduction or a flat rate can be reduced.

Thereby, the micropayment and/or fractional payment system generates an incentive to improve the trained model. Furthermore, the incentive can be designed such that a feedback is collected for data that is most needed to improve the trained model. Thereby, the feedback can be controlled.

In one embodiment, the method comprises determining a quality of the feedback message. The respective quality can be described by a quality index, e.g. a numeric value.

In one embodiment, it is decided depending on the quality of the feedback whether or not it will be used to train the existing trained model and to provide a feedback thereto. In one (another) embodiment, the reward, namely the reduction of the allocated amount is only given if the feedback as provided through the feedback message meets a certain quality criteria, e.g. the quality index is above a predefined threshold value.

In one embodiment, the method comprises the step of issuing a search request to a database, in particular a relational database, the search request at least partially being based on the client request. The respective relational database can be a private or a public database. The search request can be directly directed towards content or towards a content source. In one embodiment, where the search request is directed towards content, the response might at the same time indicate a content source e.g. a direct link to a particular article and/or a link to a server hosting the content.

The above given problem is also solved by a computer-readable medium with instructions for implementing at least one of the above-described methods when being executed by at least one processor. Similar advantages as described above are achieved.

Further, the problem is solved by a system having a computer-readable medium as described above.

Further, the problem is solved by a system for providing an (on-line) chat conversation via text messages and/or audio messages, the system comprising:
a chat application, the chat application providing at least one first participant of the chat conversation, the chat application being adapted to determine and output responses to questions issued by at least one second participant of the chat conversation;
at least one trained model, in particular an autoregressive language model, preferably a deep learning model configured such that the trained model (22) receives the questions issued by the at least one second participant, determines the responses and outputs the responses to the chat application, wherein the chat application is adapted to
a) issue a secondary request to a content source to receive content;
b) input at least partially the received content and questions in the trained model;
a payment application, adapted to:
   storing at least one client identity (ID) to identify the at least one second participant and/or a client device used by the at least one second participant;
   allocating an amount to be paid for the responses outputted by the chat application, preferably without concurrently requiring payment of the amount, using the client identity;
   monitoring a total allocated amount for a client identity, in particular a sum of a plurality of said amounts;
   transmitting a payment request, the payment request for at least partially settling the total allocated amount assigned to the client identity when the total allocated amount exceeds a (predetermined) threshold amount.

All of the above-mentioned components, comprising the chat application, the payment application and the trained model can be part of a single software component or distributed in separate software components which themselves can be distributed across several computers and interact with each other as e.g. client server applications.

In an (alternative) embodiment, the payment request can be transmitted not only when the total allocated amounts exceeds a (predetermined) threshold amount, but also when the amount has been allocated for a time longer than a pre-set threshold, e.g. more than 1 week, more than 2 weeks, more than a month, more than 3 months, or more than 6 months. Of course, there might be an option to make the payment earlier.

In one embodiment, the system, in particular the payment application, does not consider the allocated amount but only the timeframe.

While the system is generally adapted to answer a plurality of questions, it is not necessary that in step b) several questions or parts of several questions are input into the trained model. Indeed, it is possible to input a single question received from a single second participant and some content received from the content source in the trained model.

In one embodiment, the system is adapted to store certificates to authenticate the system against different content sources. In other words, there can be a database or any type of memory to store certificates which establish a trusted relationship between the system and potential content sources. The respective trusted relationship can be used to receive content automatically, e.g. over an API. Having certificates as a preferred means of establishing a trusted relationship between the system and potential content sources, does not mean that the invention is not applicable to content sources which require other credentials like user names and passwords. In accordance with the invention, any means for establishing a trusted relationship is viable. However, having respective certificates is most convenient and efficient.

Alternatively, the content sources might provide content without establishing a trusted relationship. E.g. a flag/indicator can be made available by the content source which indicates that the content source is willing to provide content to a particular and/or any LLM.

In one embodiment, the system comprises a database for storing content pricing, wherein the chat application is adapted to provide pricing information for responding to the question using the database. In one embodiment, the database comprises a relationship between content and/or content sources and the pricing information. For example, there could be a table storing content sources by descriptive name, any identifier or an URI, wherein for each entry there is a respective pricing indication, e.g. 10 Cents per retrieved page or 20 pages per request. Of course, the relationship can have any complexity, e.g. categories which allow to differentiate between certain content in a particular content source.

Alternatively and/or additionally, the trained model itself might be used to perform the pricing task. In one embodiment, the trained model might be requested to provide a cost indication for responding to a particular request, optionally taking into consideration the client, the client component, the content source, hardware requirement, time of the request and/or any other available information.

According to another embodiment, the above-given problem is also solved by the usage of a chat system with at least one trained model for responding to questions issued in the chat system to access paywalled content. The chat system may comprise an access model/interface to retrieve the paywalled content, in particular in text form, and use the retrieved paywalled content as part of an input to the trained model for responding to the client request.

In other words, the chat system forms a gateway for accessing the paywalled content and can use its advanced technology of processing language to digest the paywalled content and to produce adequate responses to questions asked by users. The respective approach has the same advantages as discussed above. In particular, it is possible to access the paywalled content on an as-needed basis, wherein for each access the user and/or the chat system might individually decide whether or not accessing the paywalled content is effective to improve a potential response given. The access interface may be an application programming interface (API) that allows transfer of all necessary data or a crawler that (directly) accesses a content source and handles all necessary data.

Further embodiments are discussed in the dependent claims and aspects at the end of the description.

### BRIEF DESCRIPTION OF THE DRAWINGS

The invention will now be described in greater detail using several exemplary embodiments and making reference to the drawings, in which:

FIG. 1 shows a client device, a chat system, a payment system and two content servers connected through the internet;

FIG. 2 shows components of the payment system in accordance with FIG. 1;

FIG. 3 shows components of the chat system in accordance with FIG. 1;

FIG. 4 shows several components of one of the content servers in accordance with FIG. 1;

FIG. 5 shows a first part of an illustrative diagram of a method for providing a response to a client request;

FIG. 6 shows a second part of an illustrative diagram of a method for providing a response to a client request; and

FIG. 7 shows an exemplary data structure for the payment system in accordance with FIG. 2.

### DESCRIPTION

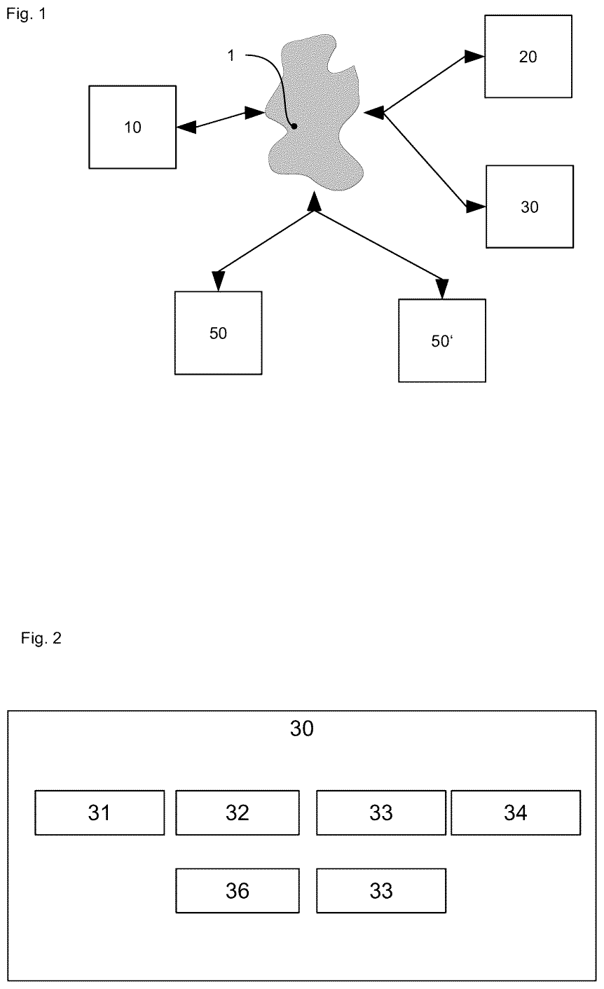

FIG. 1 shows an exemplary system according to the invention. A client component, like a client device 10, for example, a laptop, a PC or a mobile terminal is connected via a network, in the present case the internet 1, to a chat system 20. However, the system is not limited to one client device 10 and the system may also work with a plurality of client components. The chat system 20 and the client device 10 are also in communicative connection via the internet 1, with a payment system 30, for example a payment service provider, to conduct micropayments. Normally, numerous content servers 50, 50′ are connected to the internet 1 and enabled to communicate with the chat system 20 through a machine to machine interface—in one embodiment through a standardized API.

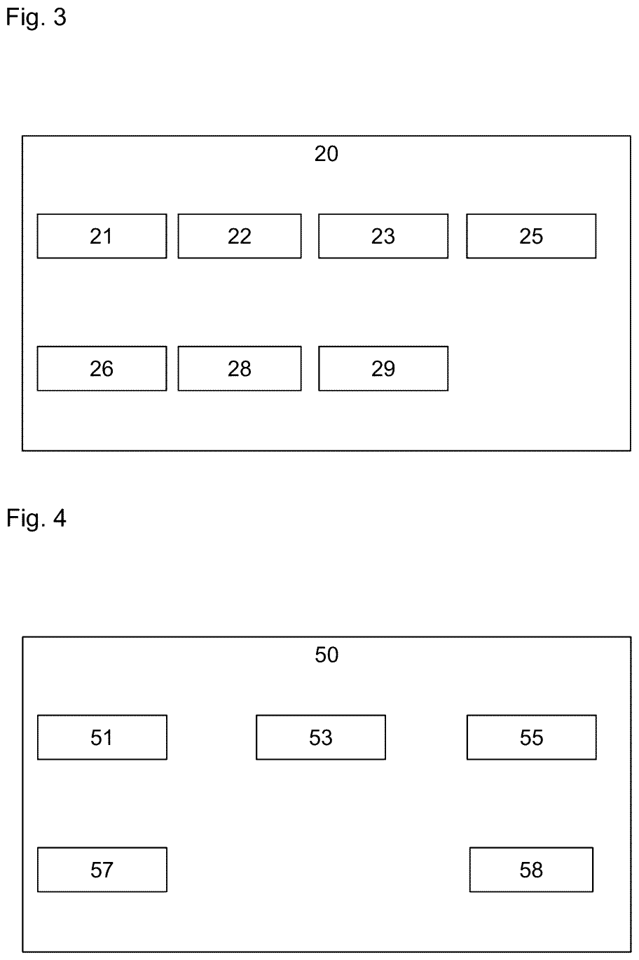

The chat system 20 can comprise a chat application 21 (FIG. 3) which can be a software program that allows users/participants to communicate with one another in real-time/near-time.

In one embodiment, the chatbot is designed for engaging in a sophisticated task, like writing an article comparing different birth-rates.

The chat application 21 can use a trained model 22 (FIG. 3) to generate the answers for a particular question provided by means of a request. In one embodiment, the trained model 22 is a large language model, e.g. a variant of the GPT (Generative Pre-trained Transformer) model. Initial training may be performed by a training application 23 which trains the model 22 on massive amounts of text data. Optionally, additional training is performed after the initial training. For the additional training, content from a content server can be used. The chat application 21 can be adapted to be used for a wide range of natural language processing (NLP) tasks, such as text generation, language translation, and question answering. Examples of the chat application 21 may be, for example, ChatGPT or Dall E, available from OpenAI, LLC; or Copilot available from Microsoft Corp.

In one embodiment, the chat application 21 is adapted to generate coherent and fluent text in a wide range of styles and formats. It can generate everything from creative writing to technical documentation, and can even mimic different writing styles and/or voices. According to the invention, the chat application 21 is adapted to provide responses taking into consideration/using paywalled content.

In one embodiment, the chat application 21 is adapted to understand and respond to context. The trained model 22 is trained on a large amount of text data such that it covers a wide range of topics and styles, which allows it to understand the context of a given input and generate appropriate responses. This makes it a powerful tool for tasks such as question answering. However, this also enables the trained model 22 to involve further data sources to provide adequate or high quality responses.

In one embodiment, the chat application 21 uses other technologies, such as voice recognition and text-to-speech systems integrated, to create more advanced and interactive applications, such as voice assistants (e.g. Siri, Alexa, Google Assistant).

The front end of the chat application 21 can take many different forms, depending on the application and the platform it is being used on. In one embodiment, it is a web-based interface that allows users to input text into a text box and receive output in a separate text area.

The front-end of the chat application 21 can be built using different technologies such as HTML, CSS, and JavaScript. These technologies are used to create an interactive and responsive web-based interface.

In one embodiment, the trained model 22 is trained on a massive amount of text data, which means that it has a large number of parameters. In one embodiment, it might have around 100 billion parameters. It is obvious that the larger the trained model 22 is, the more calculation power is necessary to process the input and generate a response.

The chat system 20 of FIG. 3 comprises a content mapper 25, an authentication application 26, a content source database 28 and a payment order application 29.

The payment order application 29 is adapted to establish a connection between an (bank) account of the user with another (bank) account. The other account may be an account associated with the content source and/or associated with the chat system 20 and/or associated the payment system 30 and/or associated with a server. In other words, the payment order application 29 is configured to settle costs.

The inventive chat application 21 is adapted to extract keywords from the request/question using the content mapper 25. In one embodiment, the keyword could be “birth rate” (see the above caption example about birth rates in Germany). After that, the content source database 28 is searched to identify/select content sources which have content regarding the term “birth rate”. The content source database 28 can for example be a relational database which can be simply queried by using a SQL statement, e.g. “SELECT SOURCES FROM CONTENT SOURCE DATABASE WHERE TEXT LIKE ‘% BIRTH RATE %=’”.

After having identified/selected adequate content sources, the chat application 21 may contact the respective content server, e.g. the content server 50. For accessing the content server 50, the content server 50 might require authentication. The respective authentication can be taken care of by the authentication application 26 which, for example, can hold a series of certificates which establish a trusted relationship between the content server 50 and the chat system 20. After establishing such a trusted relationship, the chat application can connect to an indexing application 51 of the content server 50 to e.g. identify/select articles containing the term “birth rate”. In essence, the chat application 21 can use the indexing application 51 to identify/select content which is relevant for responding to the request received. Once the content has been identified/selected, it can be extracted from a database, e.g. the relational database 53 containing content. Alternatively, the indexing application 51 can point to a file system 55 which hosts the content, e.g. in the form of a MS Word or text file.

Once the content has been identified/selected, the chat application 21 can try to retrieve the respective content. However, the respective content can be paywall-protected content meaning that the originator of the respective content requests a certain amount of money for granting access thereto. In this regard, amount of money (to be paid) and costs are used interchangeably throughout the whole description. To make the respective payment, the chat application 21 can interact with the payment system 30 which then will contact the payment gateway 57 of the content server. Access to the content server 50 can be granted through an (standardized) API. Alternatively, the content server 50 provides a web interface 58, which can be used to search and/or access certain content. Indeed, it is also possible to use a web interface 58 for performing the respective payment.

It can be one aspect of the invention, that the chat system 20 uses the payment system 30 to receive a compensation for the provided answers.

The payment system 30 comprises an identification device 31 (FIG. 2), an interface device 32 to allow communication with the chat system 20 and/or the client device 10, a memory device 33 and a processing device 34. The payment system 30 is a digital payment platform that can allow users to purchase any type of digital goods and services in a flexible and convenient way. The payment system 30 enables users to pay for digital content, such as online articles, e-books, music, and video games, without the need to enter their credit card details every time they make a purchase.

In one embodiment, the payment system 30 works by allowing users to create a potentially anonymous account, e.g. with any payment information like a credit card number, and then pre-authorize/allocates certain amounts of money, which can then be used to make purchases. This pre-authorized/allocated amount can be settled—at a later stage—with a credit card or any other payment method or by providing a service from the user which equals a certain amount of money. Thereby, the payment system 30 significantly facilitates making small, incremental payments without having these amounts immediately debited to the preferred payment method.

In one embodiment, the payment system 30 is adapted to make purchases on any website that has integrated with the payment system 30. The authorization can be given by clicking on a “Put it on my tab” button or link, which will allocate the amount to be paid to the client identity of the user. Several embodiments of a usable payment system 30 are discussed in EP 2 476 087 B1, which is hereby incorporated by reference herein in its entirety.

The payment system can be a digital payment platform that allows users to purchase digital goods and services in a flexible and convenient way, without the need of entering credit card details every time. It may allow users to pre-authorize a certain amount of money, which can then be used to make purchases and try out digital goods and services before committing to a purchase. The payment system may also provide a variety of tools for merchants to integrate the platform into their e-commerce systems.

FIG. 2 exemplarily shows possible individual components of the payment system 30. The payment system 30 according to one embodiment of the invention has an identification device 31 for recording at least one identification number of the client device 10 or the user, an interface device 32 for receiving and confirming direct debit orders from the chat system 20 or any other merchant system, wherein the debit orders comprise information relating to an amount to be paid (costs) to the chat system 20 or any other system, a memory device 33 for storing the allocated amounts in conjunction with the associated identification numbers ID and a processing device 34 for processing the incoming requests.

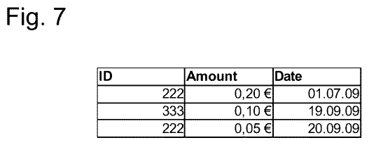

In one embodiment, the payment system 30 is adapted to identify the client component, that is, the user device 10 based purely on the MAC address. The memory device 33 thus stores the amount to be paid in conjunction with the corresponding MAC address. For this purpose, the payment system 30 comprises a corresponding database in which corresponding tables are kept. An exemplary extract from a table kept therein is shown in FIG. 7. Said table comprises, for example, three columns, specifically a first column which contains the identification of a client device 10 or a user, a second column which contains the amount to be debited and a third column which contains the date on which the direct debit order was received by the payment system 30. Each line of the table in FIG. 7 corresponds to a direct debit order. Thus, it is possible to read from the table in FIG. 7 that on 01.07.2009, 20 Eurocents were debited/allocated for identification number 222. Furthermore, on 20.09.2009, 5 Eurocents were debited for the same number. The IDs shown in the table are for illustrative purpose only. In one embodiment, they can be a MAC address. In other embodiments, they can point to other tables establishing the identity of a certain user or device. Alternatively, they can link the respective entity (device or person) to another system, e.g. by holding a Facebook or Google ID.

The processing device 34 can use these entries to determine the total payable from the debit amounts (allocated amount) for particular identification numbers ID. For example, the total payable for identification number 222 comes to 25 Eurocents.

Thus, the payment system 30 can be configured, for example, so that a particular user has to settle his debts when they are greater than 0.29 Euro or 1 Euro or 10 Euro.

As discussed, the payment system 30 can not only be used to make payments or to allocate a potential payment between the client device 10 or the respective user and the chat system, but also for payments between the chat system 20 and either one of the content servers 50, 50′. Here, payment or payment allocations can be directly made by/for the chat system 20 or routed such that the payment to the content servers stems from the user or the client device 10.

One method embodiment implementing a system as described so far could comprise the following steps:
1. Content server 50 establishes a merchant/professional account
2. Content server 50 issues an LLM access certificate (CA)
3. User or client device 10 queries the chat application 21 asking for data that is behind a paywall of the content server 50
4. Chat application 21 requests access to the content of the content server 50 using the access certificate
5. When the access certificate is validated, the content server 50 grants access for the chat application 21 to the data behind the paywall
6. A price is negotiated for the access, e.g. using the pricing application 36
7. The payment system 30 is invoked, e.g. requesting the client device 10 to acknowledge that a response to the issued questions/query will cost a certain amount of money
8. User or client device 10 accepts pricing
9. The payment system 30 allocates the respective amount
10. The payment system 30 sends an entitlement token to chat application 21
11. The chat application 21 uses the entitlement token to receive final access to the content of the content server 50
12. Once the allocated amount reaches a particular threshold, the payment system 30 request payment from the user or client device 10
13. Once the payment has been received, the content server 50 is compensated.

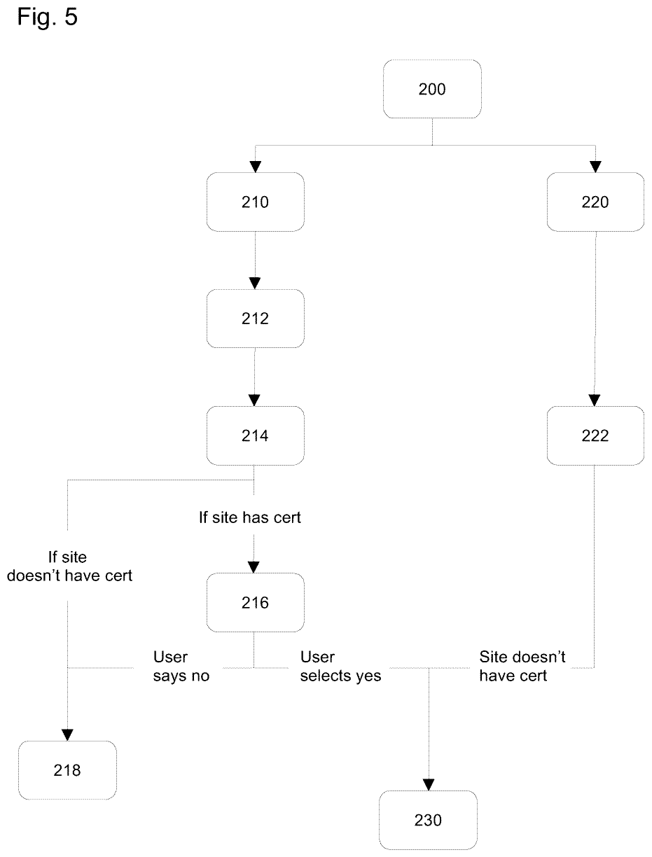

FIG. 5, 6 depict the method/process in more detail. In step 200, the chat system 20, more precisely the chat application 21, receives a client request over an interface from the client device 10. In one embodiment, the request indicates that the chat application 21 should use one of the content servers 50 or 50′ to respond to the request (right branch in FIG. 5; Step 220). Alternatively, the chat application 21 itself can determine/suggest that one of the content servers 50, 50′ is involved/selected for improving a potential response (left branch in FIG. 5; Step 210). In other words, the chat application 21 is adapted to first check whether the client request contains any indication about a content server 50, 50′ to be used and if not, tries to identify/select an appropriate proposal/content server (left branch of FIG. 5; step 212). In other words, the chat system 20 can implement both branches and decide dynamically which branch to use.

The left branch of the diagram of FIG. 5 starts by receiving a client request void of indicating a particular content server 50 or 50′ to use for responding to the client request (step 210). In one embodiment, the received request could comprise the following question: “Please tell me more about Jimmy Buffett”.

In step 212, the chat application 21 initiates a Google search for “Jimmy Buffett” and then selects the content server 50 accessible e.g. via www.creem.com as an adequate resource to enrich a potential answer. The selection algorithm can be performed under multiple criteria. In a very simple embodiment, the chat application 21 simply chooses the result which was ranked the highest by Google.

In step 214, the chat application 21 checks if the content server 50 has a certified authority (CA) certificate. A CA is a trusted organisation that issues digital certificated for websites and other entities. CAs validate a website domain and the ownership of the website and then issue TLS/SSL certificates that are trusted by a client.

If that is the case, the chat application 21 informs the user/client device 10 that the content server 50 appears to be an authority on the subject and can be trusted and inquires whether content stemming from that content server 50 should be used in the response. If the user/user device 10 declines or the content source 50 does not have a CA certificate, the chat application 21 generates a generic response without involving the additional resource (step 218).

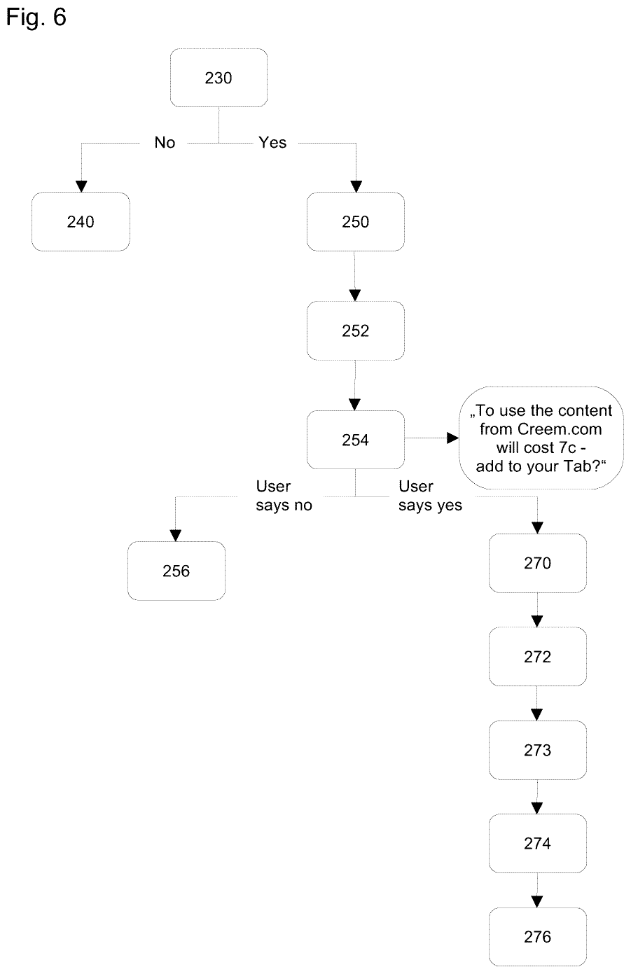

If the user/client device 10 indicates in step 216 that the content of the content server 50 should be used, the process progresses to step 230 (see also FIG. 6). Alternatively, if the user/client device 10 indicates in step 216 that the content of the content server 50 should not be used, the process progresses to step 218 generates a generic response without involving the additional resource.

As said, the right branch of FIG. 5 covers the embodiment/workflow, where the user/client device 10 indicates that a particular content server 50 should be involved. The respective request received in step 220 could contain the following wording: “Using creem.com, please tell me more about Jimmy Buffett”. Similar to step 214, the chat application 21 can immediately check in step 222, whether the content server 50 has a CA certificate. If a respective certificate is available, the process might continue with step 230.

In step 230 (FIG. 6), the chat application 21 might check whether the content server 50 has specified that access to its content is restricted. E.g. in one embodiment, the content server 50 may require a payment per access, per downloaded page, per session, etc. Alternatively or additionally, it might be checked whether any other access rules apply. In one embodiment, the respective information is provided by a metatag being part of the initial webpage of the content server 50. If the content server 50 does not require paid access, the content application 21 scrapes the content of e.g. one or several webpages for free and might use the received content for generating a response to the initial user request (step 240, then proceeding to step 273; not shown in FIG. 6). In other words, the method generates and transmits a response to the client request without requiring access to a paywalled content. This has the positive effect that, even without additional training of the trained model, an up-to-date response (output of the trained model 22) is provided.

If the content server 50 has specified that access to its content is restricted, the chat application 21 or, upon receiving a triggering signal from the chat application 21, the payment system 30, will send a certificate to the content server 50 for establishing a trusted relationship/communication between
a) the chat system 20 and the content server 50 and/or
b) the payment system 30 and the content server 50. In one embodiment, said certificate is different of the CA certificate and relates to payment, i.e., a payment certificate.

Step 250 might comprise validating the respective certificate, e.g. validating the certificate of the content server 50.

In step 252, the payment system 30 might be invoked and provides pricing e.g. from a data table indicating costs. For doing so, the pricing application 36 of the payment system 30 might be involved. Alternatively, a pricing indication might be requested from the respective content server 50, or the chat system 20 is aware of the costs since it holds an own database with pricing information for different content servers 50 and/or particular content. In other words, the costs for accessing the content server are provided and/or determined by the content server 50.

A variety of deferred payment arrangements may be considered by the chat system 20 and content servers 50, as a function of characteristics of the requested content and the user of the client device 10. For example, considering a “credit worthiness” characteristic of the user, if the user is a new user lacking credit credentials provided to the chat system 20 or payment system 30, the chat system 20 and content servers 50 may require immediate payment for paywalled content above a predetermined price threshold, and/or agree to a limited deferred payment option (“tab”), for example $5.00 or less, against which purchases of content having prices of $1.00 or less may be applied. Alternatively, if the user has a good and substantial credit history, the chat system 20 and content servers 50 may agree to a tab that exceeds $5.00 and/or content purchases having prices in excess of $1.00. Users having very strong credit histories may be permitted to defer payment for content purchases having far more substantial prices (for example, in the hundreds of dollars).

The chat system 20 and content servers 50 may also negotiate which party will bear the risk of a non-payment of the tab by the client device 10. In cases where the content servers 50, for example, agree to bear the non-payment risk associated with a user device, the content servers 50 may for example require that the chat system 20 and/or payment system 30 maintain a valid credit source (for example, credit card) for the user device in their records, and/or that the client or client device meet a predetermined “credit worthiness” metric based on credit history as described above. Other variations of these arrangements are also to be considered as aspects of this disclosure (for example, a hybrid approach may be used in which the client device makes a partial payment immediately, with a remainder to be deferred.

Deferred payment arrangements may also define additional characteristics, for example such as a payment schedule. For example, it may be agreed that the payment system 30 will accumulate payments from the user device 10 to content servers 50, and make payment to the content servers 50 of received user payments on a predetermined schedule (for example, once daily) or based on an accumulated amount (for example, when accumulated payments total more than $10.00). By accumulating payments owed to content servers 50 to some degree before paying content servers 50, the number of payment transactions and associated transaction costs can be reduced.

In step 254, the chat application 21 can present the costs determined for involving the content server 50 to the user/client component and require authorization.

If the user/client component disagrees with these costs, a generic response without involving the content server 50 might be returned in step 256. Alternatively, if the user/client component agrees to the (additional) costs, the payment system 30 will be involved to allocate the respective costs to the respective user/client component. The allocation might take place by putting the respective amount on a virtual tab associated with the user/client component by a client identity.

In that alternative scenario, the payment system 30 might pass an entitlement token to the chat application 21 which will allow it to bypass the paywall and receive content from the content server 50, e.g. by scraping the site for an answer to the original user prompt/client request, which will be the provided content.

After step 254 and after the user replied “yes” (rightmost branch in FIG. 6), the process continues with step 270 by allocating the costs for accessing content server to the client identity ID by using the payment system 30. In another embodiment, the chat system 20 may be configured to allocating the costs for accessing the content server to the client identity ID. In even another embodiment, the content source can directly allocate the costs for accessing the content server to the client identity ID.

After step 270, in step 272, the paywall of the content server is bypassed and content is received from the content server. In one embodiment, content of a plurality of content servers is obtained.

In subsequent step 273, at least parts of the received content and at least parts of the client request are input into at least one trained model 22. In one embodiment, the client request is directly provided to the trained model 22 and the trained model 22 itself accesses a search engine for obtaining content, in particular paywalled content.

In subsequent step 274, a response is generated by the trained model utilizing said client request and said one or more received content and information already contained in the trained model 22. In one embodiment, the user has already provided additional data relevant for providing the response, like family status, age, health status, hobbies etc. which may also be used by the trained model 22.

In subsequent step 276, the generated response is transmitted to the client device.

According to one embodiment, the chat application 21 will compose a response to the original client request using the provided content from the trained model 22. This has the positive effect that, even without additional training of the trained model, an up-to-date response (output of the trained model 22) is provided. In other words, traditionally, a trained model only can refer to its own training data and the training data used for training of the model has a certain date in time. The client request will occur a time after the latest training data. “up-to-date” refers to that additional content generated between the training data date and the date of the client request can be implemented into the response, without requiring additional training of the model.

In the above described embodiment, the user is always asked whether or not he is interested in making use of one of the identified/selected content servers 50, 50′. Within the scope of the invention, it is possible that the chat system 20 makes use of the content server 50, 50′ with receiving and/or requesting confirmation from the user.

In the above described embodiment, a trusted relationship between servers, machines and/or applications is established using certificates. However, this trusted relationship can also be established by other means, e.g. by a simple password and/or login name, by physical proximity (e.g. the applications are installed on the same hardware), dedicated physical or virtual connections (e.g. VPN) and others.

In another embodiment, the authentication, i.e. determining a client ID, is inherited from another device and/or application.

In another embodiment, the trust-relationship between the client or client component and the content server or chat application is inherited from another device and/or application.

In another embodiment, the trained model directly receives the client request and operates a search engine (e.g. Google, Bing etc). When paywalled content is to be accessed, the steps as described above (steps 250, 254, 270, 272, 274, 276) for accessing the paywalled content are performed.

In another embodiment, when allocating the costs for the transmission of the response, the allocation is separated into two couples with essentially three parties. The first party is represented by the client component (or client identity). The second party is represented by the chat system 20 and/or payment system 30 and/or trained model 22. The third party is represented by the content source (one or more content servers 50, 50′). As there may be multiple content sources involved, each content server may act as a separate third party. The first couple is formed between the first party and the second party. The second couple is formed by the second party and the third party. In other words, the first party is not directly connected to the third party, but both are connected through the second party.

When it comes to payment of content, which occurs between the first party and the third party, the second party acts as an intermediary. This has the advantage that the second party has already established connections to multiple third parties, which may not easily be possible for the first party. For example, when the client request is “Plan a trip to the beach next weekend”, a first content server provides weather information, a second server provides accommodation information and a third server provides information regarding a surfing equipment rental service. All or some of the above information may be paywalled content. For example, accurate weather information may cost 10 cents, accommodation information may be for free and reliable rental information may require 15 cents. Once the user agrees to the costs, all information are received by the second party and the user is provided with an answer to his request.

Alternatively, the payment of content is handled by the second party and the third party. Thereby, the obligation regarding the third party is already settled. The obligation of the first party towards the second party remains, e.g. as a credit (or tab).

Data relating to said payment information may be stored in a database, e.g. as shown in FIG. 7. Additionally, a receipt of one of the above transactions between the first/second party and the third party may be stores in the database. The receipt may be provided to the first party at a later point in time. Further, the columns as shown in FIG. 7 may be increased by a column for the first and/or second and/or third party involved in a payment. Payment of the paywalled content can be performed as described in any of the embodiments above.

In another embodiment, still referring to the three parties introduced above, when allocating the costs for the transmission of the response, the allocation occurs between the first party and the third party. In other words, the second party is not involved in the payment. Further, the first party may allocate money to multiple third parties at once (e.g. through another payment provider) and/or each separately. Again, data relating to said payment information may be stored in a database, e.g. as shown in FIG. 7. Further, the columns as shown in FIG. 7 may be increased by a column for the first and/or second and/or third party involved in a payment.

According to another embodiment, if the user (first party) has promised payment but finally, does not pay, payment from the second party to the third party may be withheld. In other words, payment from the third party to the third party is only conducted after the first party has payed to the second party. Both transactions may be stored in the same or different databases. The payment data stored between the second party and the third party may not be payed by user, but may be payed on a timeframe-basis, e.g. monthly or weekly or daily. By this trust-based relationship, the paywalled content can be acquired reliably and a profound response can be provided to the client, thereby increasing energy efficiency.

In another embodiment, in line with the other embodiments described above, however, further comprising a step of acquiring payment information from the client ID before providing an answer (e.g. before taking any steps for providing an answer). Acquiring payment information does not necessarily mean that a payment has to be made. This step rather focuses on the willingness to pay for the to-be-provided response. E.g., after payment information have been received, a first credit of, e.g., 1, 3 or 5 $ is granted to the client component. The first credit may be used for paying content providers for content for providing a response to one or more client requests. After the first credit is used up, a first request for payment is sent to the client ID. If the first request is met and payment is made, a second credit, preferably larger than the first credit, e.g. 5, 10 or 20 $, may be granted to the client ID. Again, after the second credit is used up, a second request for payment is sent to the client ID. If the second request is met and payment is made, a third credit, preferably larger than the second credit, e.g. 10, 20 or 50 $, is granted to the client ID. In other words, the credit is granted after acquiring, optionally verifying, payment information from the client ID. Further, the credit may be variable and may increase after a payment has been received from the client ID. Optionally, the credit may increase after every second or third payment, or increase steeply at the beginning and then remain constant at a higher level.

In summary, all of the above embodiments of the present invention allow reliable energy savings due to directly providing up-to-date answers to questions of users. In particular, when using a trained model, the inventive method and system allow the usage of a pre-trained model which does not require immediate training updates, thereby saving valuable energy for training of a new model, and is still capable of providing up-to-date responses to questions of users. Additionally, by providing a unified access environment for paywalled content, which can quickly retrieve relevant information, client component usage time and server usage time are reduced, thereby facilitating economic use of energy resources.

In the above described embodiments, Google may be used as a search engine for identifying/selecting an adequate content source. However, for the invention, any available search engine like Bing, Yahoo, Yandex, etc. can be used. The invention can alternatively involve any private or public search engine. Also, it is not necessary to first identify/select a server and then search the server for relevant content. In accordance with the invention, e.g. any public or private index server can be used to find content. In that embodiment it is possible to check the availability of certain certificates or trusted relationships after having identified/selected the content, e.g. a front page of the New York Times.

In the above described embodiments, a single content server 50 was selected for enriching and/or generating the response. In accordance with the invention, the response can be composed using several (different) content servers 50, 50′ and/or by requesting several documents from a single or a plurality of content servers 50, 50′. In accordance with the invention, it is possible to aggregate the information drawn from the different content source and/or to rate content, e.g. the credibility thereof by comparing the received information.

In many of the described embodiments, the payment is allocated. Of course, in accordance with the invention the system, e.g. the payment system 30, can also request and/or implement an immediate payment, e.g. via credit or debit card or via any other currency, e.g. digital currencies like bitcoins.

Further, it is possible that—in accordance with the invention—the payment system 30 offers a prepaid wallet containing money which was previously filled up so that a payment can be performed. Alternatively, the wallet can be post-paid—meaning that a payment is required once a certain threshold has been reached.

Of course, it is also within the scope of the invention that a payment, e.g. 1 Dollar is received whereby only a small amount, e.g. 1 Cent is spend immediately. The remaining amount (99 Cents) can be credited and spend at a later point in time.

Also, at least in one of the above captioned embodiment the payment system 30 can work as a money distributer so that the user can perform a single payment and the payment system 30 distributes the money between the involved entities.

In the above described embodiments, the client device contains hardware separate from the hardware hosting the LLM. In accordance with the invention the LLM might at least partially be hosted on the client device itself. In this scenario it is an option that the trusted relationship is established between the client device and one or several content servers. However, establishing the trusted relationship, e.g. by using a certificate, is optional.

At this point, it should be noted that all of the parts described above are claimed to be relevant to the invention when considered alone and in any combination, especially of the details shown in the drawings.

According to another embodiment and a first aspect, an artificial-intelligence (“AI”) application server-implemented method comprises the steps of: a) receiving a user prompt over an interface from a user device; b) determining a user identity based on at least one of a user and the user device issuing the prompt; c) processing the user prompt to select at least one content server for providing particular digital content useable for generating a response to the user prompt; d) transmitting a content request to the selected content server to provide the particular digital content; e) receiving the particular digital content from the selected content server in response to the content request; f) processing by at least one AI trained model associated with the AI application server, at least parts of the received particular digital content and at least parts of the user prompt to create processed information; g) transmitting to the user device in response to the user prompt, responsive information based at least in part on the processed information; and h) intermittently processing by a training AI application associated with the AI application server, the user identity and at least parts of at least one of the received particular digital content, the output information, and user prompt to update the at least one trained AI model.

According to a second aspect, in the method according to the first aspect, the step of intermittently processing by a training AI application associated with the AI application server adaptively updates the at least one AI trained model with regard to the user identity

According to a third aspect, in the method according to the second aspect, the step of intermittently processing by a training AI application associated with the AI application server adaptively updates the at least one AI trained model further comprises processing at least parts of the at least one AI trained model.

According to a fourth aspect, in the method according to the second aspect, the AI application server comprises a plurality of processors.

According to a fifth aspect, in the method according to the fourth aspect, the step of intermittently processing by a training AI application associated with the AI application server adaptively updates the at least one AI trained model is performed in part by at least one processor that is not the processor performing the step f).

According to a sixth aspect, in the method according to the first aspect, the method further comprises the step of: i) determining the costs by at least one of the user and user device associated with the user identity, for the transmission of the responsive information.

According to a seventh aspect, in the method according to the sixth aspect, step i) is performed without concurrently requiring payment of the amount by the at least one of the user and user device associated with the user identity.

According to an eighths aspect, in the method according to the sixth aspect, the method further comprises the steps of: d1) determining a cost for receiving a response to the content request based at least in part based on information from the content server; and d2-1) allocating the amount in step i) by using at least in part a (micro) payment system.

According to a ninth aspect, in the method according to the eights aspect, the method comprises the steps of: d1a) transmitting a cost indication to the user device based on the determined cost, wherein the allocation in accordance with step d2-1) only takes place upon receipt of an authorization signal indicative of that the at least one of the user and user device is authorizing allocation of an amount that correlates to the cost indication for receiving the response to the client request.

According to a tenth aspect, in the method according to the eights aspect, the step of determining a cost for receiving a response to the content request further comprises retrieving from a database content pricing, wherein such content pricing is based on at least one of pricing for the content, the content server, and a pre-arranged relationship between the content server and at least one of the content source AI application server and an account associated with the user identity.

According to an eleventh aspect, in the method according to the eights aspect, the step of determining costs for responding to the request comprises calculation of required electricity for generating the response to the request.

According to a twelfth aspect, in the method according to the first aspect, the method further comprising the steps of: a. monitoring a total allocated amount for a particular user identity; b. transmitting a payment request, the payment request for at least partially settling the total allocated amount assigned to the particular user identity when the total allocated amount exceeds at least one of a threshold amount or incurred before a threshold time; and c. determining costs for responding to the request.

According to a thirteenth aspect, in the method according to the first aspect, the step c) comprises the step of issuing a search request to a database, wherein the search request is at least based in part on the client request.

According to a fourteenth aspect, in the method according to the first aspect, the step c) comprises the step of authenticating at least one of the user device or AI application server relative to the content server.

According to a fifteenth aspect, in the method according to the first aspect, the step of authenticating at least one of the user device or AI application server relative to the content server comprises the step of storing certificates of authentication for the content server in a respective memory device associated with the at least one of the user device or AI application server.

According to a sixteenth aspect, in the method according to the first aspect, step c) comprises the step of performing an internet search for the at least one content server.

According to a seventeenth aspect, in the method according to the first aspect, step c) further comprises utilizing a ranking model algorithm to determine the at least one content server for providing particular digital content based on in part, on at least one of the relevance of digital content available from respective content servers, the cost associated with such digital content from respective content servers, and any pre-arranged relationship between the AI application server and the respective content servers.

According to an eighteenth aspect, in the method according to the first aspect, the at least one trained model is an autoregressive language model and a deep learning model.

According to a nineteenth aspect, in the method according to the first aspect, the user prompt comprises at least one of a question, request, an image, audio file and video file.

According to another embodiment, a method for providing a response to a client request, e.g. an image, text, comprising the steps of: a) Receiving a client request (200) over an interface from a client component, in particular a client device (10); b) Determining a client identity (ID) of a user issuing the request and/or the client component; c) Processing the client request to identify at least one content source which provides content, in particular paywalled content (relevant) for responding to the client request; d) Issuing a secondary request to the identified content source to provide content; e) Receiving content from the identified content source in response to the secondary request; f) Inputting at least parts of the received content and at least parts of the client request into at least one trained model (22), in particular an autoregressive language model, preferably a deep learning model; g) Transmitting at least partially the output of the trained model (22), to the client component to provide the response to the client request; h) optionally allocating an amount to be paid for the transmission of the response, preferably without concurrently requiring payment of the amount, using the client identity (ID).

The method of said other embodiment above, further comprising the steps of: d1) determining, in particular by involving the content source, cost for receiving a response to the secondary request; d2-1) allocating the amount in step d1) by involving a (micro) payment system.

The method of said other embodiment above, further comprising the steps of d1a) transmitting a cost indication to the client component based on the determined costs, where the allocation in accordance with step d2-1) only takes place if an authorisation signal is received, the authorisation signal indicating that the user of the client component is accepting to allocate an amount that correlates to the cost indication for receiving the response to the client request.

The method of said other embodiment above, further comprising the steps of a) Monitoring a total allocated amount for a particular client identity (ID); b) Transmitting a payment request, the payment request for at least partially settling the total allocated amount assigned to the particular client identity (ID) when the total allocated amount exceeds a (predetermined) threshold amount; c) determining costs for responding to the request, the step preferably comprising the calculation of required electricity for calculating a response to the request and/or the necessary calculation power for at least partially calculating a response to the client request.

The method of said other embodiment above, wherein the step c) further comprises issuing a search request to a database, in particular a relational database, the search request at least partially being based on the client request.

The method of said other embodiment above, wherein step c) further comprises authenticating the client component or a chat system, preferably performing step c) against the content source.

According to a further embodiment, a computer readable media with instructions for implementing the method according to said other embodiment above when being executed by at least one processor.

According to a further embodiment, a system for providing an (on-line) chat conversation via text messages and/or audio messages, in particular implementing the method according to said other embodiment above, the system comprising:
a chat application (21) for providing at least one first participant of the chat conversation, the chat application (21) being adapted to determine and output responses to questions issued by at least one second participant of the chat conversation;
at least one trained model (22), in particular an autoregressive language model, preferably a deep learning model used by the software application to determine the responses, wherein the chat application (21) is adapted to a) issue a secondary request to a content source to receive content; b) input at least partially the received content and questions in the trained model;
a payment application (30):
   storing at least one client identity (ID) to identify the second participant and/or a client component used by the further participant;
   being adapted to allocate an amount to be paid for the responses outputted by the chat application, preferably without concurrently requiring payment of the amount, using the client identity;
   monitoring a total allocated amount for a particular client identity;
   transmitting a payment request, the payment request for at least partially settling the total allocated amount assigned to the particular client identity when the total allocated amount exceeds a (predetermined) threshold amount.

The system of said further embodiment above, wherein the system is adapted to store certificates to authenticate the system against different content sources.

The system of said further embodiment above, further comprising a database for storing content pricing, wherein the chat application is adapted to provide pricing information for responding to a question using the database, preferably wherein the database comprises a relationship between content and/or content sources and the pricing information.

Another embodiment comprises usage of a chat system (20) with at least one trained model (22), in particular an autoregressive language model, preferably a deep learning model, for responding to questions issued in the chat system to access paywalled content, wherein the chat system comprises an access model to retrieve the paywalled content, in particular in text form, and uses the retrieved paywalled content as part of an input to the trained model for responding to a client request.

Another embodiment comprises the usage above, further comprising the chat system involving a (micro) payment system for performing a payment to the content provider of the paywalled content.

### REFERENCE SIGNS

1 Internet
10 client device
20 Chat system
21 Chat application
22 Trained model, e.g. LLM
23 Training application
25 Content Mapper
26 Authentication application
28 Content Source Database
29 Payment Order Application
30 Payment system
31 Identification device
32 Interface device
33 Memory device
34 Processing device
36 Pricing Application
50, 50′ Content Server
51 Indexing Application
53 Relational Database with Content
55 File System
57 Payment Gateway
58 Web Interface
ID Identification number
200 Step 200: Receiving a client request
210 Step 210: Receiving request without specified content server
212 Step 212: Selecting content server by chat application
214 Step 214: Checking if content server has a CA certificate
216 Step 216: Suggest generating response using content server
218 Step 218: Generating a generic response
220 Step 220: Receiving request including content server
222 Step 222: Checking if content server has a CA certificate
230 Step 230: Checking for access to content server
240 Step 240: Scraping content of content server
250 Step 250: Validating certificate of content server
252 Step 252: Providing pricing
254 Step 254: Presenting a cost for accessing content server
256 Step 256: Returning generic response
270 Step 270: Allocating cost for accessing content server
272 Step 272: Bypassing paywall and receiving content
273 Step 273: Inputting received content and client request to trained model
274 Step 274: Generating response by trained model
276 Step 276: Transmitting generated response to client device

1. A method for providing an artificial-intelligence system responsive to a client request, comprising the steps of:
a) receiving the client request over an interface from a client device;
b) determining a client identity (ID) associated with at least one user device issuing the request;
c) processing the client request to identify at least one content source which provides paywalled content for responding to the client request;
d) obtaining an index of content based on the user request, wherein the index identifies paywalled content of the at least one content source;
e) determining a cost and payment terms of the at least one content source for a deferred payment arrangement for obtaining the paywalled content;
f) confirming a selection of the paywalled content of the at least one content source based on a characteristic of the client and the associated payment terms of the at least one content source;
g) issuing at least one secondary request to the at least one content source to provide the selected content;
h) receiving the selected content from the at least one content source in response to the secondary request;
i) inputting at least parts of the received content and at least parts of the client request into at least one trained model;
j) transmitting at least partially an output of the trained model, to the client component to provide the response to the client request; and
k) allocating an amount to be paid for the received content without concurrently requiring payment of the amount to a payment system, using the ID.

2. The method of claim 1, wherein step f) further comprises the steps of:
providing cost information for the paywalled content to the user device; and
obtaining an indication from the user device to proceed to obtain the paywalled content.

3. The method of claim 2, wherein the cost is zero, in exchange for an acknowledgement from the user device that the user will provide a service.

4. The method of claim 1, wherein the client characteristic of step f) comprises a credit worthiness characteristic of the client.

5. The method according claim 1, wherein step c) includes the step of:
bypassing a paywall of the content source by the artificial-intelligence system to receive the selected content.

6. The method of claim 1, wherein step f) includes the step of:
receiving an authorization signal indicating that the user of the client device is accepting to allocate an amount that correlates to indication total cost for receiving the response to the client request.

7. The method according to claim 1, comprising, prior to step j), the step of:
generating an output by the trained model, based on the input of step i).

8. The method according to claim 1, comprising the steps of:
monitoring a total allocated amount, in particular a sum of a plurality of said amounts, the ID; and
transmitting a payment request to the client device, the payment request for at least partially settling the total allocated amount assigned to the ID when the total allocated amount exceeds a predetermined threshold amount.

9. The method according to claim 6, wherein a new predetermined threshold amount for receiving a subsequent payment request is increased after a payment has been received from the client device for the payment request.

10. The method of claim 1, wherein the step c) further comprises:
issuing a search request to a database of the artificial-intelligence system, the search request at least partially being based on the client request.

11. The method of claim 1, wherein the step d) further comprises:
authenticating the artificial-intelligence system, preferably against the at least one content source.

12. The method of claim 1, wherein the step b) further comprises:
acquiring and verifying payment information from the ID.

13. A system for providing an artificial-intelligence system responsive to a client request, the system comprising:
a chat application, the chat application providing at least one first participant of the chat conversation, the chat application being adapted to determine and output responses to questions issued by at least one second participant of the chat conversation;
at least one trained model, in particular an autoregressive language model, preferably a deep learning model configured such that the trained model receives the questions issued by the at least one second participant, determines the responses and outputs the responses to the chat application,
wherein the chat application is adapted to
a) issue at least one secondary request to a content source to receive content;
b) input at least partially the received content and questions in the trained model;
a payment application, adapted to:
store at least one client identity (ID) to identify the at least one second participant and/or a client component used by the at least one second participant;
allocate an amount to be paid for the responses outputted by the chat application, preferably without concurrently requiring payment of the amount, using the ID;
monitor a total allocated amount for the ID, in particular a sum of a plurality of said amounts; and
transmit a payment request, the payment request for at least partially settling the total allocated amount assigned to the ID when the total allocated amount exceeds a predetermined threshold amount.

14. The system according to claim 13, wherein the system is adapted to store certificates to authenticate the system against different content sources.

15. The system according to claim 13, comprising:
a database for storing content pricing, wherein the chat application is adapted to provide pricing information for responding to the questions using the database, preferably wherein the database comprises a relationship between content and/or content sources and the pricing information.

16. A method for providing an artificial-intelligence system responsive to a client request, comprising the steps of:
a) receiving the client request over an interface from a client device;
b) determining a client identity (ID) of at least one of a user, and client component, issuing the request;
c) processing the client request to identify/select at least one content source which provides content, in particular paywalled content for responding to the client request;
d) issuing at least one secondary request to the identified/selected content source to provide content;
e) receiving content from the identified/selected content source in response to the secondary request;
f) inputting at least parts of the received content and at least parts of the client request into at least one trained model, in particular an autoregressive language model, preferably a deep learning model;
g) transmitting at least partially the output of the trained model to the client component to provide the response to the client request;
h) optionally allocating an amount to be paid for the transmission of the response, preferably without concurrently requiring payment of the amount, using the ID.
